(19) United States
(12) Patent Application Publication
(10) Pub. No.: US 2017/0311759 A1
(43) Pub. Date: Nov. 2, 2017

(54) BEAN GRINDING MACHINE

(71) Applicant: Tsann Kuen (Zhangzhou) Enterprise Co., Ltd., Zhangzhou (CN)

(72) Inventors: Zhiqiang Xue, Zhangzhou (CN); Shangkun Liu, Zhangzhou (CN); Yanxiang Zhang, Zhangzhou (CN); Honghai Chen, Zhangzhou (CN)

(73) Assignee: Tsann Kuen (Zhangzhou) Enterprise Co., Ltd., Zhangzhou (CN)

(21) Appl. No.: 15/488,851

(22) Filed: Apr. 17, 2017

(30) Foreign Application Priority Data
Apr. 27, 2016 (CN) 201610267932.1

(51) Int. Cl. A47J 42/50; B02C 2/10; A47J 42/02; A47J 42/38; B02C 25/00; B02C 23/02

(52) U.S. Cl. CPC A47J 42/50; B02C 25/00; B02C 23/02; A47J 42/02; A47J 42/38; B02C 2/10

(57) ABSTRACT

A bean grinding machine includes a base seat, a bean container mounted on the base seat, and a grinding mechanism removably mounted on the base seat. The grinding mechanism includes first and second grinding members which are rotatable relative to and cooperate with each other to define a grinding space for receiving beans introduced from the bean container. Both the first and second grinding members can be removed from the base seat for facilitating cleaning.

### CROSS-REFERENCE TO RELATED APPLICATION

This application claims priority of Chinese Patent Application No. 201610267932.1, filed on Apr. 27, 2016.

### FIELD

The disclosure relates to a bean grinding machine, and more particularly to a bean grinding machine with two grinding members cooperatively operated for grinding coffee beans or the like into a powder.

### BACKGROUND

A conventional bean grinding machine generally includes a base seat, a bean container mounted on the base seat for receiving coffee beans, and a grinding assembly mounted on the base seat, and including an upper grinding member and a lower grinding member cooperatively operated for grinding coffee beans into a powder. The upper grinding member is removable from the base seat to be cleaned, while the lower grinding member, which is disposed to be rotatable relative to the upper grinding member for grinding work, cannot be detached from the base seat. As such, bean powder residues remaining in the grinding machine may easily get mildewed and cause bad odor.

### SUMMARY

Therefore, an object of the disclosure is to provide a bean grinding machine that can alleviate at least one of the drawbacks of the prior art.

According to the disclosure, the bean grinding machine includes abase seat, a bean container mounted on the base seat, and a grinding mechanism removably mounted on the base seat. The grinding mechanism includes a first grinding member and a second grinding member which are rotatable relative to and cooperate with each other to define a grinding space for receiving beans introduced from the bean container. Both the first and second grinding members can be removed from the base seat for facilitating cleaning.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of an embodiment of a bean grinding machine according to the disclosure;

FIG. 2 is a sectional view of the embodiment in which a bean container and a grinding mechanism are disengaged from a base seat;

FIG. 3 is a sectional view of the embodiment in which the bean container and the grinding mechanism are engaged with the base seat;

FIG. 4 is a fragmentary sectional view of a portion of the embodiment in a state where a second anchoring member is in a locking position;

FIG. 5 is a sectional view of the grinding mechanism of the embodiment;

FIG. 6 is a fragmentary perspective view of a portion of the embodiment;

FIG. 7 is a fragmentary, exploded perspective view of a portion of the embodiment;

FIG. 8 is a perspective view illustrating a structural relationship among a driven gear, a driving gear and a transmitting gear of the embodiment;

FIG. 9 is a fragmentary sectional view of a portion of the embodiment in a state where the second anchoring member is in an unlocking position;

FIG. 10 is a fragmentary sectional view of a portion of the embodiment illustrating when the grinding mechanism is being mounted on the base seat;

FIGS. 11 and 12 are fragmentary sectional views illustrating a downward movement of a first grinding member;

FIG. 13 is a fragmentary perspective view of a bean container and a second micro switch of the embodiment; and

FIGS. 14 and 15 are fragmentary, cross-sectional views illustrating when the bean container is being mounted on the base seat and actuating the second micro switch.

### DETAILED DESCRIPTION

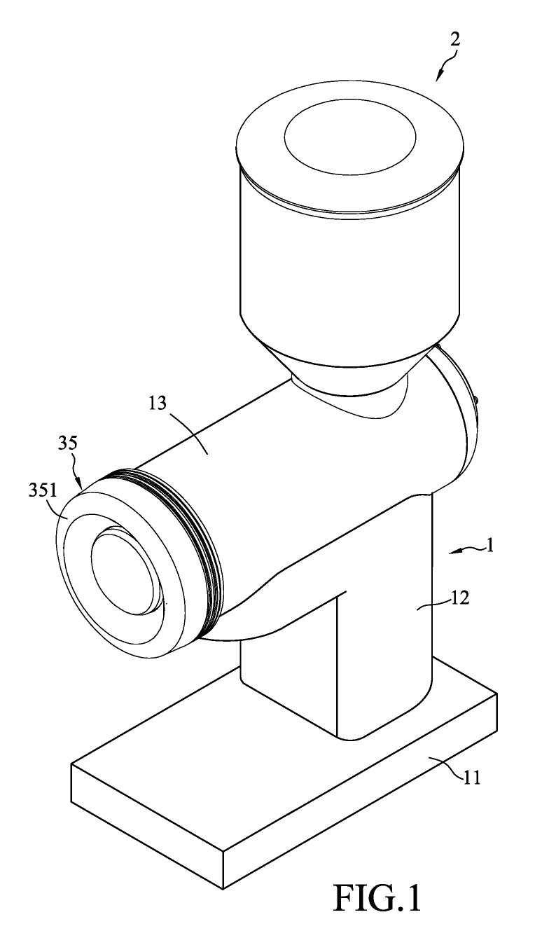

Referring to FIGS. 1 to 3, an embodiment of a bean grinding machine includes abase seat 1, a bean container 2, a grinding mechanism 3, a power mechanism 4, a locking mechanism 5, a first micro switch 6 and a second micro switch 7.

The base seat 1 includes a base wall 11 for standing on a surface, a surrounding wall 12 extending upwardly from the base wall 11 and configured to define an accommodation space 120 for mounting the power mechanism 4 therein, and a mounting wall 13 connected with the surrounding wall 12 and extending in a horizontal direction to define a mounting space 130 for mounting the grinding mechanism 3 therein and to terminate at a lateral opening 131 for access to the mounting space 130. The mounting wall 13 has an upper opening 132 disposed to be in spatial intercommunication between the mounting space 130 and the bean container 2.

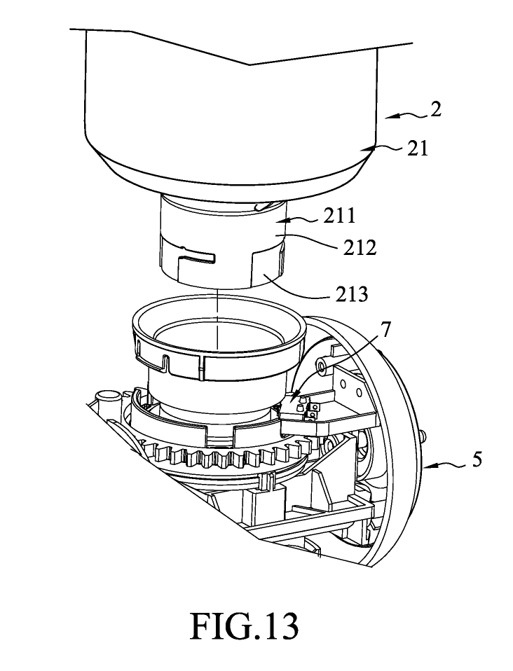

The bean container 2 is removably connected to the upper opening 132 to be disposed upwardly of the grinding mechanism 3. The bean container 2 includes a container body 21 and a cap 22. The container body 21 defines therein a containing space 210 in spatial communication with the mounting space 130 for dispensing coffee beans into the mounting space 130 by gravity. Referring to FIG. 13, the container body 21 has an annular neck 211 having a groove 213 in an outer surface 212 thereof.

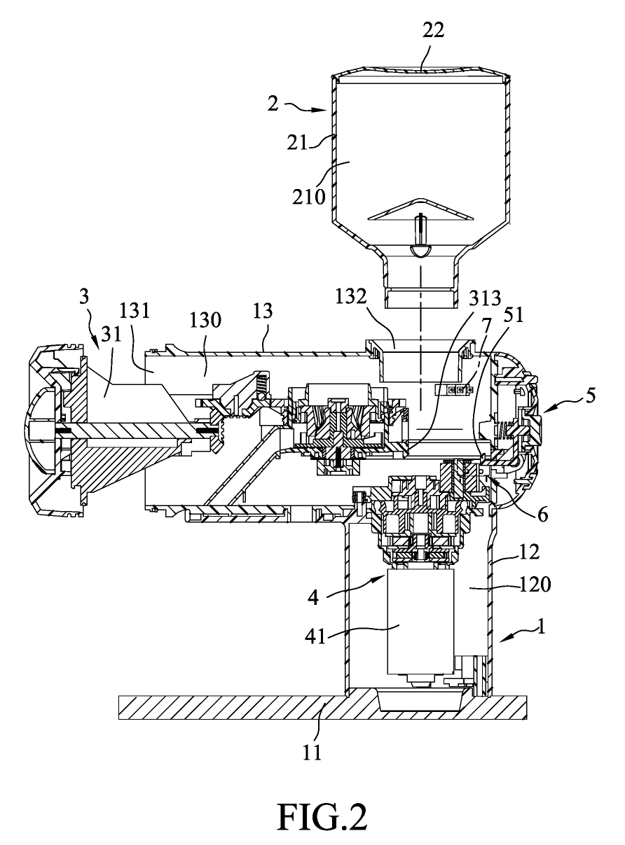

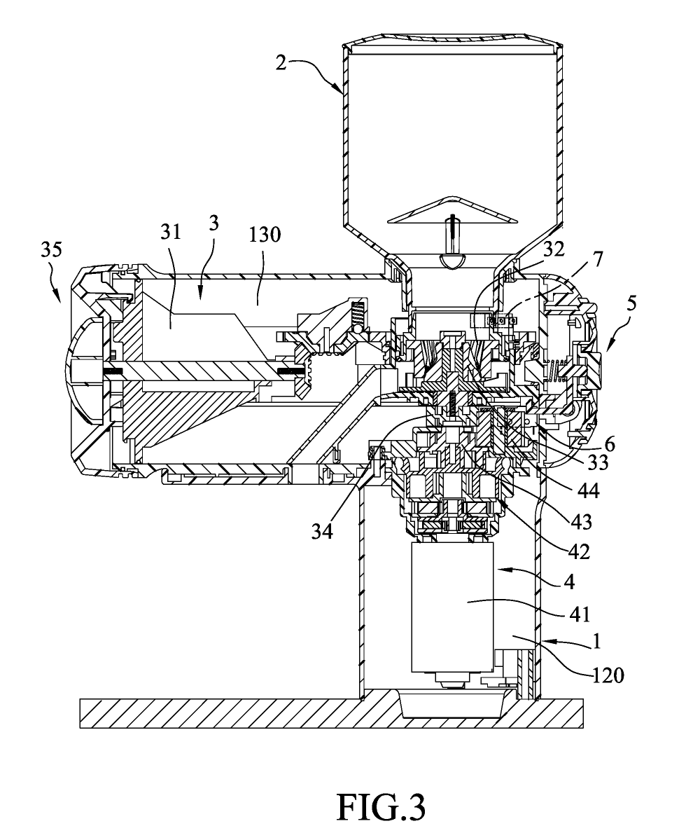

Referring to FIGS. 2 and 3, the grinding mechanism is mounted in the mounting space 130, and is disengageable from the base seat 1 in the horizontal direction so as to be removed from the mounting space 130 through the lateral opening 131. The grinding mechanism 3 includes a mounting frame 31, first and second grinding members 32, 33 which are mounted on the mounting frame 31 and which are rotatable relative to and cooperate with each other to define a grinding space 30 for receiving coffee beans introduced from the bean container 2, a driven gear 34 which is disposed to couple the second grinding member 33 with the power mechanism 4, and a particle size adjusting unit 35.

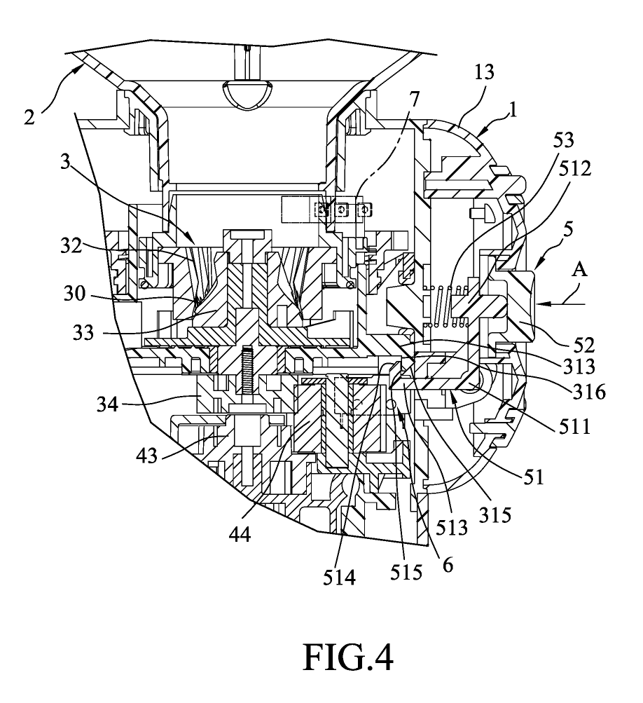

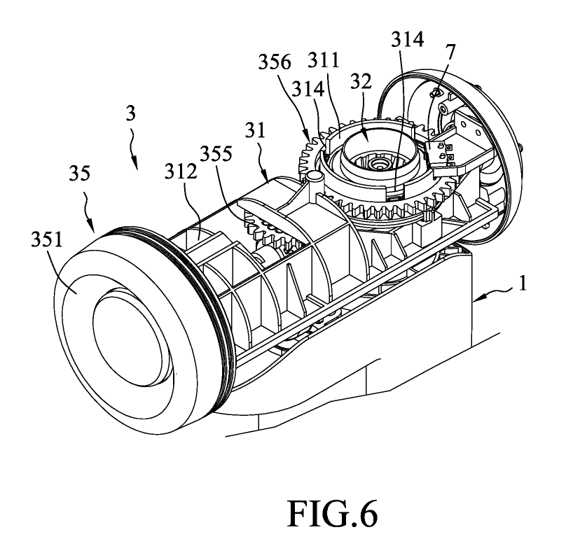

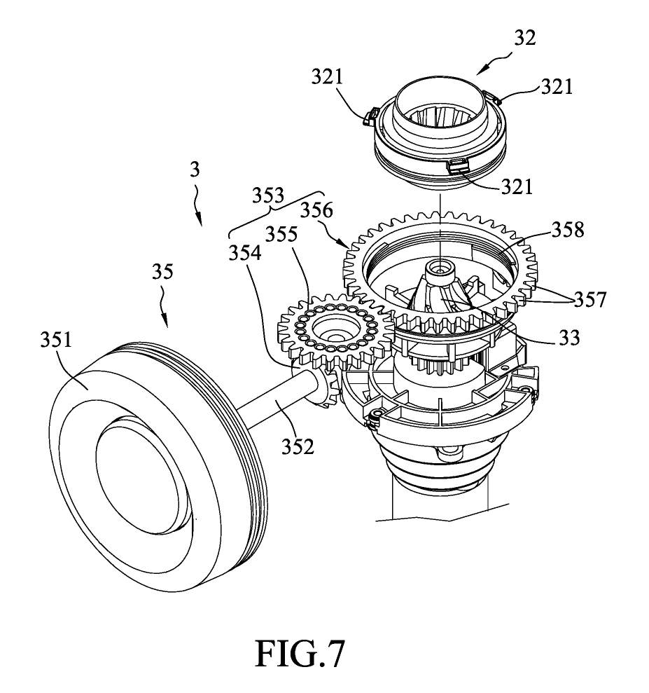

Referring to FIGS. 4 to 7, the mounting frame 31 includes a first mounting portion 311 for mounting the first grinding member 32 thereon, a second mounting portion 312 connected to a lateral side of the first mounting portion 311 for mounting the particle size adjusting unit 35 thereon, and a first anchoring member 313 projecting from the first mounting portion 311 toward the locking mechanism 5. The first mounting portion 311 has a plurality of key slots 314 spaced apart from each other. The first anchoring member 313 has a downwardly extending end portion in a form of a dog structure which has a first leading surface 315 facing and inclined toward the locking mechanism 5, and a first trailing surface 316 extending uprightly from the first leading surface 315. The first grinding member 32 is disengageable from the mounting frame 31, and is disposed to surround the second grinding member 33. The first grinding member 32 includes a plurality of radially extending keys 321 in a spline engagement with the key slots 314 such that the first grinding member 32 is non-rotatably mounted on the mounting frame 31.

The particle size adjusting unit 35 has a rotary shaft 352 which is rotatably mounted on the second mounting portion 312 about a horizontal axis and which has an operated end 351 in the form of an adjusting knob that is disposed adjacent to the lateral opening 131 (see FIG. 2) for being manually operable, and a bevel gear assembly 353 which interconnects the rotary shaft 352 and the first grinding member 32 to convert a rotational drive of the rotary shaft 352 about the horizontal axis into a rotational drive about an upright axis so as to move the first grinding member 32 along the upright axis. Specifically, the bevel gear assembly 353 includes a first bevel gear 354 coupled to and rotated with the rotary shaft 352 about the horizontal axis, a second bevel gear 355 having a bevel gear portion 3551 which meshes with the first bevel gear 354 and a transition gear portion 3552 which is disposed coaxially with the bevel gear portion 3551, and an adjusting annular seat 356 having an annular toothed portion 357 which meshes with the transition gear portion 3552 to be rotated about the upright axis, and an internally threaded portion 358 which is disposed coaxially with the annular toothed portion 357. Since the first grinding member 32 is non-rotatably mounted on the mounting frame 31, and is threadedly engaged with the internally threaded portion 358, rotation of the adjusting annular seat 356 about the upright axis results in movement of the first grinding member 32 along the upright axis so as to vary a size of the grinding space 30 between the first and second grinding members 32, 33.

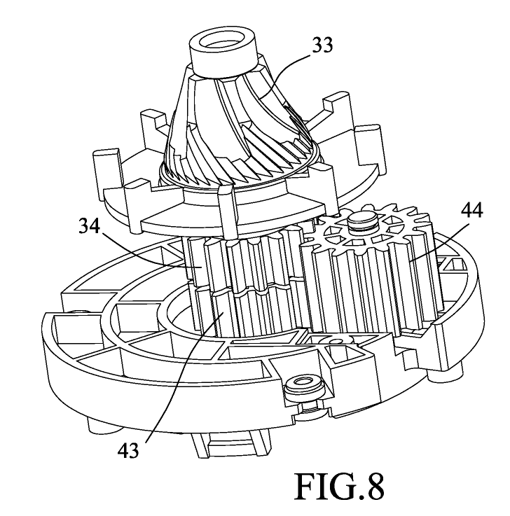

Referring to FIGS. 3, 4 and 8, the power mechanism 4 is mounted in the accommodation space 120 of the base seat 1, and includes a power motor 41, a reduction gear assembly 42 driven by the power motor 41 to have a rotational drive with a required torque, a driving gear 43 coupled with the reduction gear assembly 42 to receive the rotational drive, and a transmitting gear 44 which meshes with the driving gear 43 and the driven gear 34 of the grinding mechanism 3 so as to transmit a rotational drive received from the transmitting gear 44 to rotate the second grinding member 33 relative to the first grinding member 32.

Referring to FIGS. 2, 4 and 9, the locking mechanism 5 is mounted on the mounting wall 13 of the base seat and opposite to the lateral opening 131 in the horizontal direction to lock the grinding mechanism 3 to the base seat 1. The locking mechanism 3 includes a second anchoring member 51, an operated member 52 and a biasing member 53.

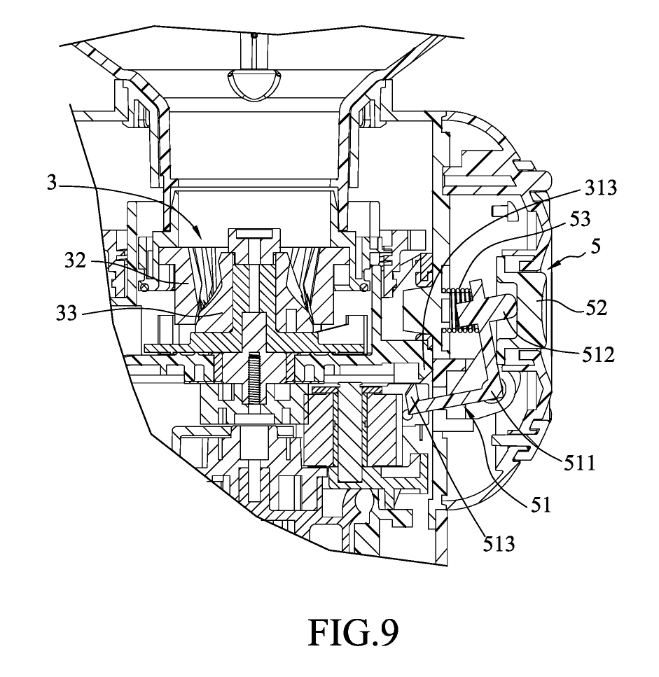

The second anchoring member 51 is disposed to be movable relative to the base seat 1 between a locking position, as shown in FIG. 4, where the second anchoring member 51 is engaged with the first anchoring member 313 to retain the grinding mechanism 3 in the mounting space 130, and an unlocking position, as shown in FIG. 9, where the second anchoring member 51 is disengaged from the first anchoring member 313 so as to permit disengagement of the grinding mechanism 3 from the base seat 1. Specifically, the second anchoring member 51 has a fulcrum portion 511 pivotally mounted on the base seat 511, and a driven portion 512 and an anchoring portion 513 which are disposed at opposite ends of the fulcrum portion 511 and respectively engageable with the operated member 52 and the first anchoring member 313, such that turning of the fulcrum portion 511 by operating the operated member 52 results in disengagement of the anchoring portion 513 from the first anchoring member 313 to move the second anchoring member 51 to the unlocking position. The anchoring portion 513 has a second trailing surface 514 facing and inclined toward the first anchoring member 313, and a second leading surface 515 extending uprightly from the second trailing surface 514.

The operated member 52 is movably mounted on the mounting wall 13 and is engaged with the driven portion 512 such that the operated member 52 can be pressed in a direction indicated by arrow (A) of FIG. 4 toward the grinding mechanism 3 to bring the second anchoring member 51 to turn to the unlocking position as shown in FIG. 9.

The biasing member 53 is in the form of a biasing spring which is disposed between the second anchoring member 51 and a wall of the base seat 1 to bias the second anchoring member 51 toward the locking position.

The first micro switch 6 is disposed in the mounting space 130 and adjacent to the second anchoring member 51, and is actuated by the grinding mechanism 3 when mounting of the grinding mechanism 3 on the base seat 1 is completed. The second micro switch 7 is disposed in the mounting space 130 and adjacent to the upper opening 132, and is actuated by the bean container 2 when mounting of the bean container 3 on the base seat 1 is completed. With such a structure, only when both the grinding mechanism 3 and the bean container 2 are mounted correctly on the base seat 1, the first and second micro switches 6, 7 can be actuated to bring a circuit (not shown) in the bean grinding machine to an ON-state for conducting a grinding work.

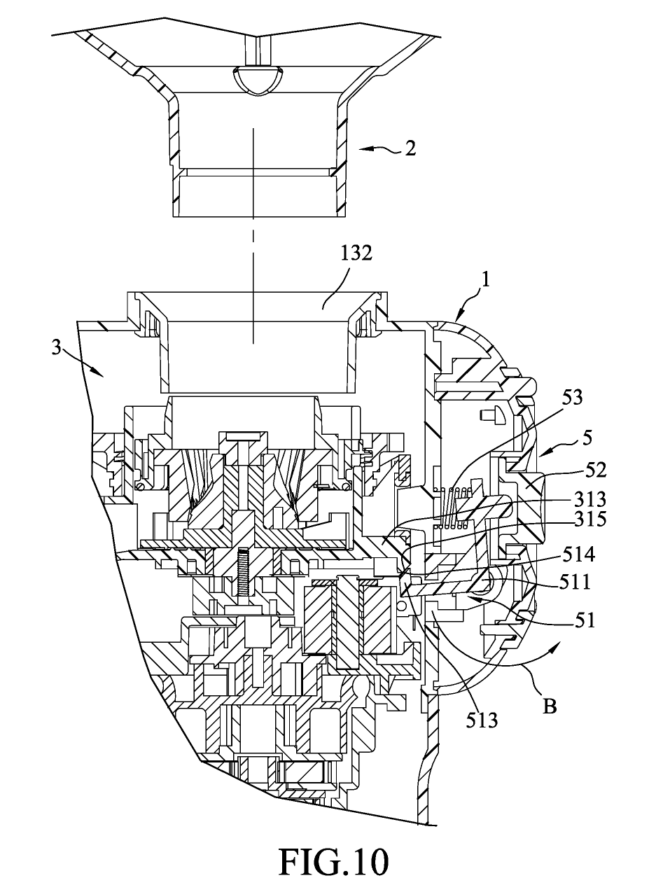

Referring to FIGS. 2, 4 and 10, in assembly, the grinding mechanism 3 is inserted into the mounting space 130 through the lateral opening 131 (as shown in FIG. 2) toward the locking mechanism 5 (as shown in FIG. 10). Then, by slightly turning the second anchoring member 51 in a direction of arrow (B) to lower the anchoring portion 513 so as to pass the first leading surface 315 over the second trailing surface 514, the first trailing surface 316 is brought in abutment against the second leading surface 515, following returning of the second anchoring member 51 to the locking position by means of the biasing member 53, so as to retain the first anchoring member 313 to the second anchoring member 51. In this state, the driven gear 34 meshes with the transmitting gear 44 of the power mechanism 4 in the accommodation space 120, and the first micro switch 6 is actuated.

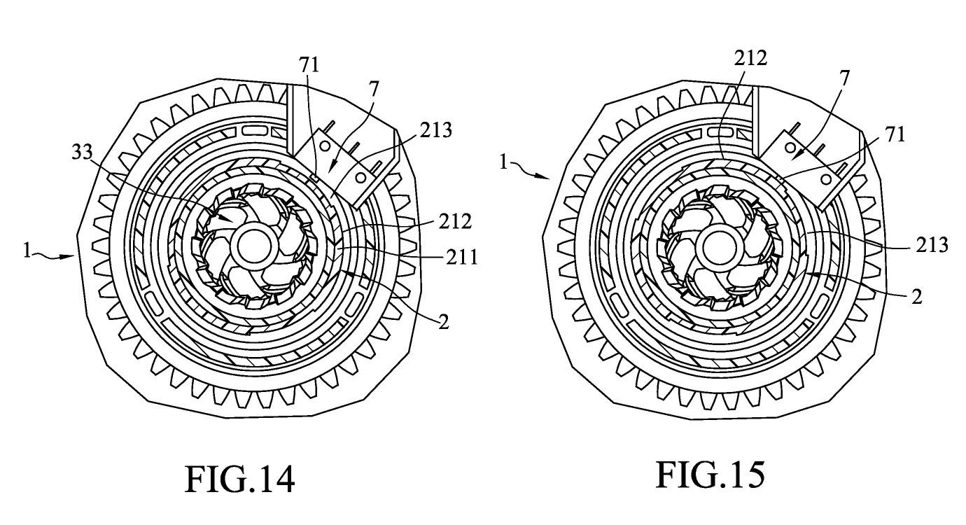

Referring to FIGS. 2, 3, 13 to 15, the annular neck 211 of the bean container 2 is inserted into the mounting space 130 from the upper opening 132 to align the groove 213 with a protrusion 71 of the second micro switch 7 (as shown in FIGS. 14 and 15). At this stage, the bean container 2 is not in contact with the second micro switch 7, as shown in FIG. 14. Subsequently, the bean container 2 is turned clockwise to retain thereof to the base seat 1 in a known manner, and to permit the outer surface 212 of the neck 211 to contact the second micro switch 7 for actuating the second micro switch 7, as shown in FIG. 15.

In use, a given amount of coffee beans in the containing space 210 of the bean container 2 is transported to the grinding space 30 by gravity. The power motor 41 is actuated to rotate the second grinding member 33 relative to the first grinding member 32 for grinding the coffee beans into a powder.

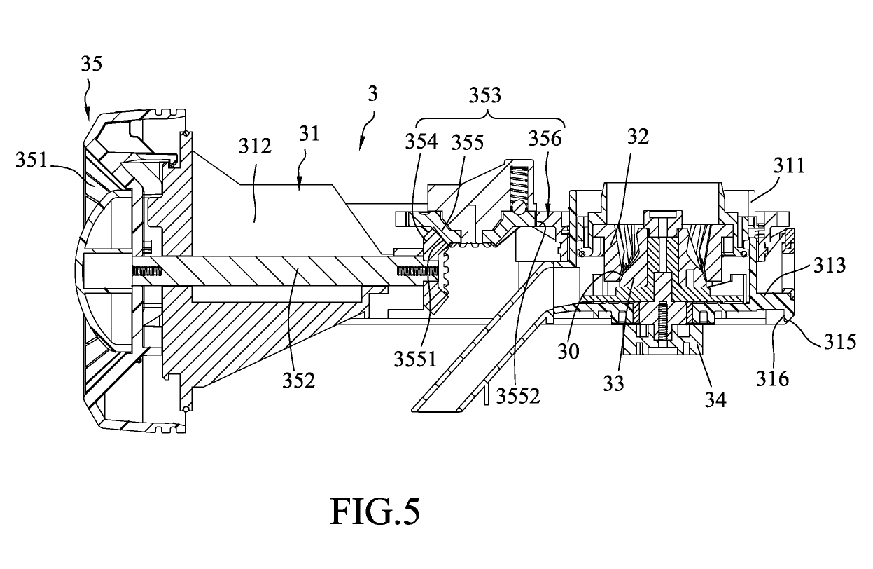

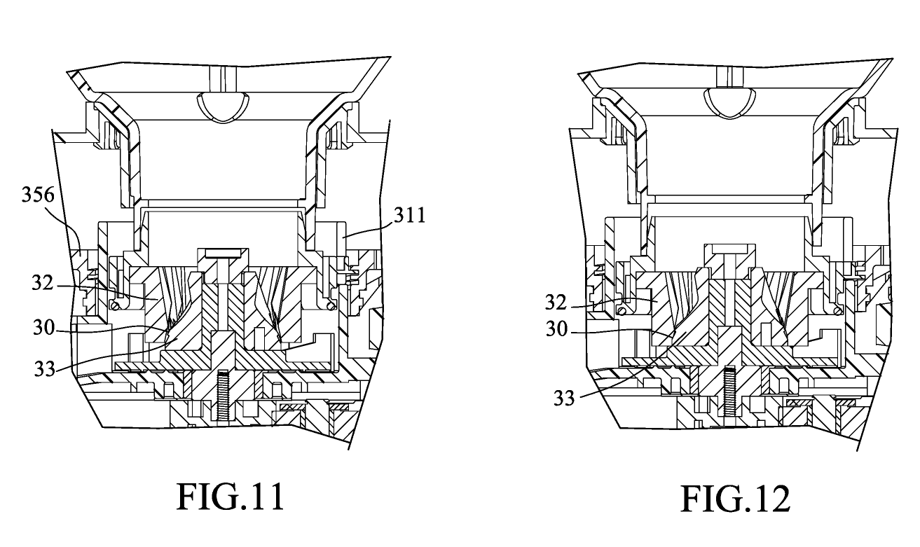

Referring to FIGS. 5, 6, 11 and 12, when it is desired to adjust the size of ground powder, the operated end 351 of the particle size adjusting unit 35 is turned about the horizontal axis of the rotary shaft 352 to drive rotation of the adjusting annular seat 356 about the upright axis through the first and second bevel gears 354, 355. Thus, the first grinding member 32, which is non-rotatably mounted on the mounting frame 31 and which is threadedly engaged with the adjusting annular seat 356, is moved along the upright axis by the rotation of the adjusting annular seat 356 so as to vary a size of the grinding space 30 for adjusting the size of ground powder of the beans. FIG. 12 illustrates the state that the first grinding member 32 is lowered to reduce the size of the grinding space 30 from the state shown in FIG. 11.

Referring to FIGS. 2, 4 and 9, the bean container 2 can be removed from the base seat 1 by counterclockwise turning and upwardly moving the bean container 2 through the upper opening 132. Subsequently, the operated member 52 is pushed by a user to turn the second anchoring member 51 to the unlocking position, as shown in FIG. 9, where the anchoring portion 513 is disengaged from the first anchoring member 313. The user can horizontally move the grinding mechanism 3 along the mounting space 130 to remove the same outwardly of the base seat 1 for cleaning. Further, the first grinding member 32 can be disengaged from the mounting frame 31 for facilitating cleaning. Also, a cutter (not shown) of the second grinding member 33 can be disposed to be removable therefrom for facilitating cleaning.

As illustrated, with the grinding mechanism 3 removably mounted on the base seat 1, the first and second grinding members 32, 33 can be removed from the base seat 1 to be readily cleaned to prevent the ground powder from remaining in the grinding mechanism 3. Besides, with such a construction, the grinding mechanism 3 is easy to be assembled and disassembled, and is retained firmly to the base seat 1 by means of the locking mechanism 5.

While the disclosure has been de scribed in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

1. A bean grinding machine comprising:
a base seat;
a bean container mounted on said base seat for containing beans to be ground; and
a grinding mechanism removably mounted on said base seat, and including a first grinding member and a second grinding member which are rotatable relative to and cooperate with each other to define a grinding space for receiving the beans introduced from said bean container.

2. The bean grinding machine as claimed in claim 1, wherein said grinding mechanism is mounted on said base seat such that said grinding mechanism is disengageable from said base seat in a horizontal direction.

3. The bean grinding machine as claimed in claim 1, wherein said grinding mechanism includes a mounting frame on which said first and second grinding members are mounted, said first grinding member being disengageable from said mounting frame.

4. The bean grinding machine as claimed in claim 3, further comprising a locking mechanism which is disposed on said base seat to lock said grinding mechanism to said base seat, said mounting frame having a first anchoring member, said locking mechanism including a second anchoring member which is disposed to be movable relative to said base seat between a locking position, where said second anchoring member is engaged with said first anchoring member to retain said grinding mechanism on said base seat, and an unlocking position, where said second anchoring member is disengaged from said first anchoring member so as to permit disengagement of said grinding mechanism from said base seat.

5. The bean grinding machine as claimed in claim 4, wherein said locking mechanism includes an operated member disposed to be operated to move said second anchoring member to the unlocking position, said second anchoring member having a fulcrum portion pivotally mounted on said base seat, and a driven portion and an anchoring portion which are disposed at opposite ends of said fulcrum portion and respectively engageable with said operated member and said first anchoring member, such that turning of said fulcrum portion by operating said operated member results in disengagement of said anchoring portion from said first anchoring member.

6. The bean grinding machine as claimed in claim 5, wherein said locking mechanism includes a biasing member disposed to bias said second anchoring member toward the locking position.

7. The bean grinding machine as claimed in claim 6, wherein said first anchoring member has a first leading surface facing and inclined toward said second anchoring member, and a first trailing surface extending uprightly from said first leading surface, said anchoring portion having a second trailing surface facing and inclined toward said first anchoring member, and a second leading surface extending uprightly from said second trailing surface such that said first trailing surface is brought in abutment against said second leading surface by passing said first leading surface over said second trailing surface so as to retain said first anchoring member to said second anchoring member when said second anchoring member is in the locking position.

8. The bean grinding machine as claimed in claim 1, wherein said base seat includes a mounting wall configured to define a mounting space for mounting said grinding mechanism therein, and a lateral opening for access to said mounting space such that said grinding mechanism is removable from said mounting space in a horizontal direction through said lateral opening.

9. The bean grinding machine as claimed in claim 8, further comprising a power mechanism, said base seat further including a base wall for standing on a surface, and a surrounding wall extending upwardly from said base wall and configured to define an accommodation space for mounting said power mechanism therein, said bean grinding machine further comprising a locking mechanism which is mounted on said mounting wall and remote from said lateral opening in the horizontal direction.

10. The bean grinding machine as claimed in claim 3, wherein said first grinding member is non-rotatably mounted on said mounting frame and surrounds said second grinding member, said second grinding member being rotatably mounted on said mounting frame, said bean grinding machine further comprising a power mechanism which is mounted on said base seat, said power mechanism including a driving gear which is disposed to receive a rotational drive from a power source, and a transmitting gear which meshes with said driving gear, said grinding mechanism further including a driven gear which meshes with said transmitting gear to transmit a rotational drive received from said transmitting gear to rotate said second grinding member.

11. The bean grinding machine as claimed in claim 3, wherein said grinding mechanism further includes a particle size adjusting unit disposed to move said first grinding member relative to said second grinding member along an upright axis so as to vary a size of said grinding space, said particle size adjusting unit having a rotary shaft which is rotatably mounted on said mounting frame about a horizontal axis and which has an operated end for being manually operable, and a bevel gear assembly which interconnects said rotary shaft and said first grinding member to convert a rotational drive of said rotary shaft about the horizontal axis into a rotational drive about the upright axis so as to move said first grinding member along the upright axis.

12. The bean grinding machine as claimed in claim 11, wherein said bevel gear assembly includes a first bevel gear coupled to and rotated with said rotary shaft about the horizontal axis, a second bevel gear having a bevel gear portion which meshes with said first bevel gear and a transition gear portion which is disposed coaxially with said bevel gear portion, and an adjusting annular seat having an annular toothed portion which meshes with said transition gear portion to be rotated about the upright axis, and an internally threaded portion which is disposed coaxially with said annular toothed portion, said first grinding member being non-rotatably mounted on said mounting frame and threadedly engaged with said internally threaded portion such that rotation of said adjusting annular seat about the upright axis results in movement of said first grinding member along the upright axis.

13. The bean grinding machine as claimed in claim 1, further comprising a first micro switch disposed on said base seat and actuated by said grinding mechanism when mounting of said grinding mechanism on said base seat is completed.

14. The bean grinding machine as claimed in claim 13, wherein said bean container is removably mounted on said base seat, and further comprising a second micro switch disposed on said base seat and actuated by said bean container when mounting of said bean container on said base seat is completed.

15. The bean grinding machine as claimed in claim 14, wherein said base seat includes a mounting wall configured to define a mounting space for mounting said grinding mechanism therein, a lateral opening for access to said mounting space such that said grinding mechanism is removable from said mounting space in a horizontal direction through said lateral opening, and an upper opening disposed to be in spatial intercommunication between said mounting space and said bean container.

16. The bean grinding machine as claimed in claim 2, wherein said grinding mechanism includes a mounting frame on which said first and second grinding members are mounted, said first grinding member being disengageable from said mounting frame.
